(19) United States
(12) Patent Application Publication
(10) Pub. No.: US 2009/0167073 A1
(43) Pub. Date: Jul. 2, 2009

(54) VEHICLE SEATS

(75) Inventor: Masahiro FUJIEDA, Kakamigahara-shi (JP)

Correspondence Address: GREENBLUM & BERNSTEIN, P.L.C., 1950 ROLAND CLARKE PLACE, RESTON, VA, 20191, US

(73) Assignee: TOYOTA BOSHOKU KABUSHIKI KAISHA, Aichi-ken (JP)

(21) Appl. No.: 12/339,447

(22) Filed: Dec. 19, 2008

(30) Foreign Application Priority Data
Dec. 26, 2007 (JP) 2007-334729

(51) Int. Cl. B60N 2/68

(52) U.S. Cl. 297/452.18; 297/463.1

(57) ABSTRACT

A vehicle seat can include a base frame, a slide rail assembly having a slide member, and a seatbelt anchor bracket. The base frame has a bottom wall portion that is connected to the slide member via a fastener. The seatbelt anchor bracket is fastened between the base frame bottom wall portion and the slide member via the fastener.

This application claims priority to Japanese patent application serial number 2007-334729, the contents of which are incorporated herein by reference.

### BACKGROUND OF THE INVENTION

1. Field of the Invention

The present invention relates to vehicle seats. More particularly, the present invention relates to slidable vehicle seats.

2. Description of Related Art

For example, as shown in FIG. 3, a slidable vehicle seat (a driver seat) is already known. The vehicle seat has a seat cushion frame 101, a seat back frame 102 that is rotatably connected to the seat cushion frame 101 via a reclining mechanism (not shown), and a pair of slide rail assemblies 180. Naturally, the vehicle seat has a seat cushion pad, a seat cushion cover, a seat back pad and a seat back cover. However, the pads and the covers are omitted in the drawings for clarity.

The seat cushion frame 101 has a pair of (inner and outer/right and left) lower arms 110. The lower arms 110 are positioned in parallel so as to be laterally spaced at a desired distance, and are integrally connected to each other via a pair of lateral frame elements 111. Each of the lower arms 110 has a vertical main arm portion 112 and a horizontal lower attachment portion 114.

Each of the slide rail assemblies 180 is constituted of a lower rail 130 and an upper rail 120. The lower rails 130 are disposed on a vehicle floor F. The lower rails 130 are positioned in parallel so as to be laterally spaced at a desired distance, and are fixedly connected to the vehicle floor F via mounting blocks 140. The upper rails 120 are respectively slidably coupled to the lower rails 130 so as to move therealong.

The seat cushion frame 101 is disposed on the slide rail assemblies 180 such that the lower attachment portions 114 of the lower arms 110 are respectively seated on upper surfaces 122 of the upper rails 120. The lower attachment portions 114 of the lower arms 110 are respectively connected to the upper rails 120 via two (front and rear) pairs of bolts 116 and nuts 118 (FIG. 4).

The vehicle seat further has a seatbelt buckle 150. The seatbelt buckle 150 is attached to the seat cushion frame 101. In particular, a seatbelt anchor 152 is integrally connected to the seatbelt buckle 150. The seatbelt anchor 152 is connected to a seatbelt anchor bracket 160 via a pair of bolt and nut. The seatbelt anchor bracket 160 has a lower bent portion 160a. The lower bent portion 160a is positioned on the lower attachment portion 114 of the inner (left) lower arm 110 and is connected to the lower attachment portion 114 via one (the rear pair) of the two pairs of the bolts 116 and the nuts 118. Thus, the seatbelt anchor bracket 160 is fixedly connected to the inner lower arm 110. As a result, the seatbelt buckle 150 can be attached to the seat cushion frame 101.

Generally, when a vehicle collision happens, a large (inertial) force can be unexpectedly applied to the occupant sitting on the vehicle seat. As a result, a large tensile force (which force may be referred to as a seatbelt loading) can be applied to the seatbelt via the occupant, so that the seatbelt anchor bracket 160 can be pulled upwardly via the seatbelt. At this time, if an excessively large force is applied to the seatbelt anchor bracket 160 via the seatbelt, as shown by broken lines in FIG. 4, the seatbelt anchor bracket 160 can be deformed (extended) upwardly while it is deformed inwardly. Deformation of the seatbelt anchor bracket 160 may cause reduced restraint performance of the seatbelt. As a result, the occupant sitting on the vehicle seat cannot be reliably restrained by the seatbelt.

Such a vehicle seat is taught, for example, by Japanese Laid-Open Patent Publication Number 2004-122825.

### BRIEF SUMMARY OF THE INVENTION

In one aspect of the present invention, a vehicle seat may include a base frame, a slide rail assembly having a slide member, and a seatbelt anchor bracket. The base frame has a bottom wall portion that is connected to the slide member via a fastener. The seatbelt anchor bracket is fastened between the base frame bottom wall portion and the slide member via the fastener.

According to this aspect, the seatbelt anchor bracket is fixedly connected to the base frame while it is pressed downwardly by the bottom wall portion of the base frame. Therefore, even if an excessively large force is applied to the seatbelt anchor bracket via a seatbelt (e.g., when a vehicle collision happens), the seatbelt anchor bracket can be effectively prevented from being deformed (extended) upwardly. As a result, restraint performance of the seatbelt can be maintained, so that an occupant sitting on the vehicle seat can be reliably restrained by the seatbelt. In addition, according to this aspect, it is not necessary to improve (reinforce) the seatbelt anchor bracket so as to prevent deformation of the seatbelt anchor bracket when the excessively large force is applied thereto.

Optionally, a flanged portion can be formed in a rear end periphery of the bottom wall portion in order to strengthen the same.

Other objects, features and advantages of the present invention will be readily understood after reading the following detailed description together with the accompanying drawings and the claims.

### BRIEF DESCRIPTION OF THE DRAWINGS

FIG. 1 is a partially perspective view of a vehicle seat according to a representative embodiment of the present invention, in which a seat cushion pad, a seat cushion cover, a seat back pad and a seat back cover are omitted;

FIG. 2 is a cross-sectional view taken along line II-II in FIG. 1, which illustrates an attachment structure of a seatbelt buckle to a seat cushion frame;

FIG. 3 is a view similar to FIG. 1, which illustrates a conventional vehicle seat; and

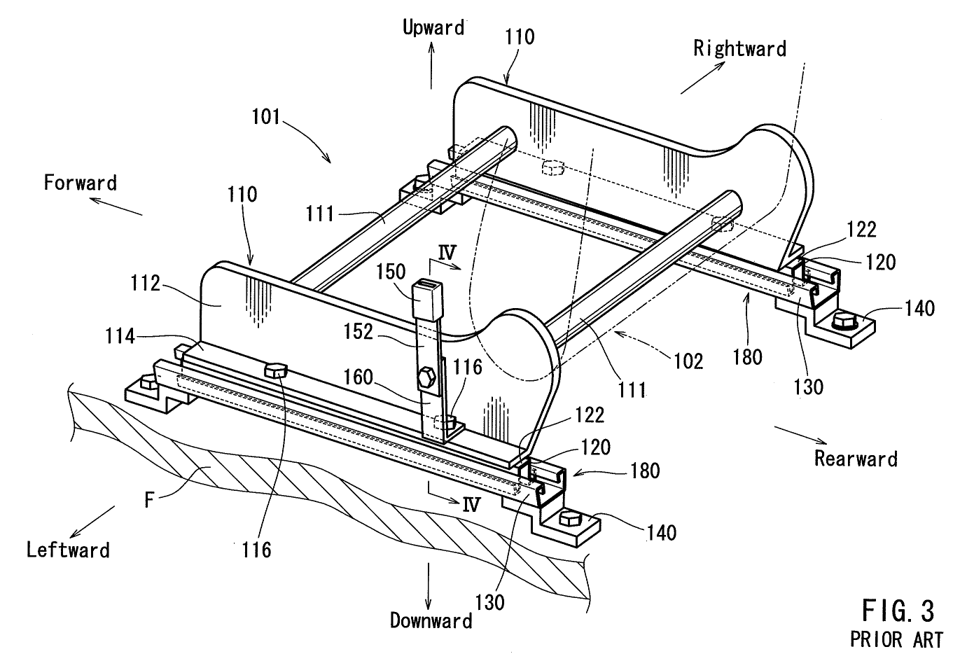

FIG. 4 is a cross-sectional view taken along line IV-IV in FIG. 3, which illustrates an attachment structure of a seatbelt buckle to a seat cushion frame.

### DETAILED DESCRIPTION OF THE INVENTION

A representative example of the present invention has been described in detail with reference to the attached drawings. This detailed description is merely intended to teach a person of skill in the art further details for practicing preferred aspects of the present invention and is not intended to limit the scope of the invention. Only the claims define the scope of the claimed invention. Therefore, combinations of features and steps disclosed in the foregoing detail description may not be necessary to practice the invention in the broadest sense, and are instead taught merely to particularly describe detailed representative examples of the invention. Moreover, the various features taught in this specification may be combined in ways that are not specifically enumerated in order to obtain additional useful embodiments of the present invention.

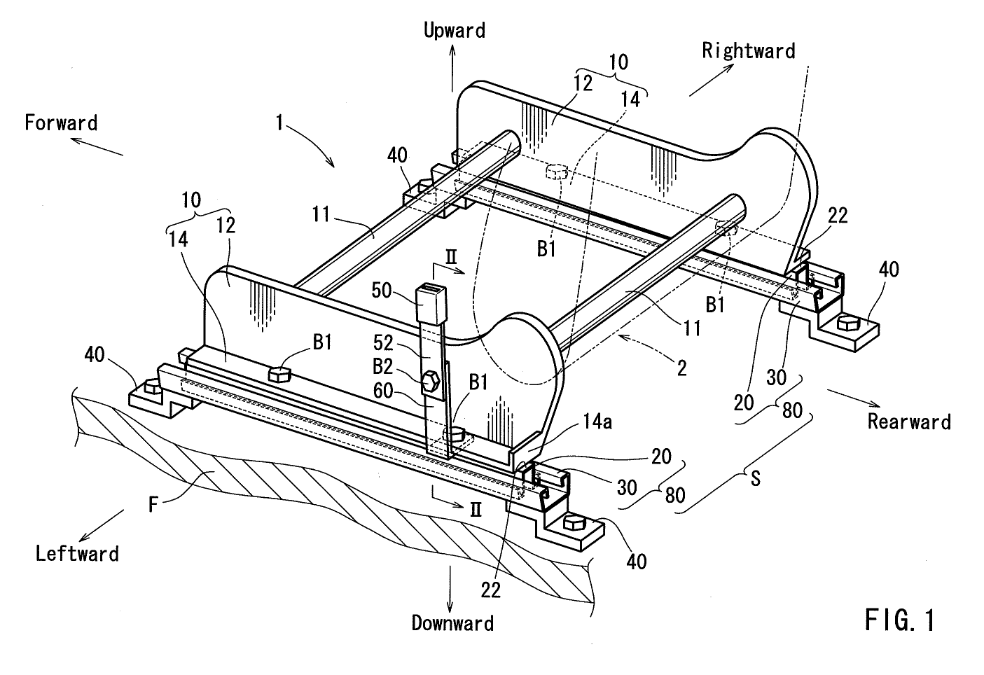

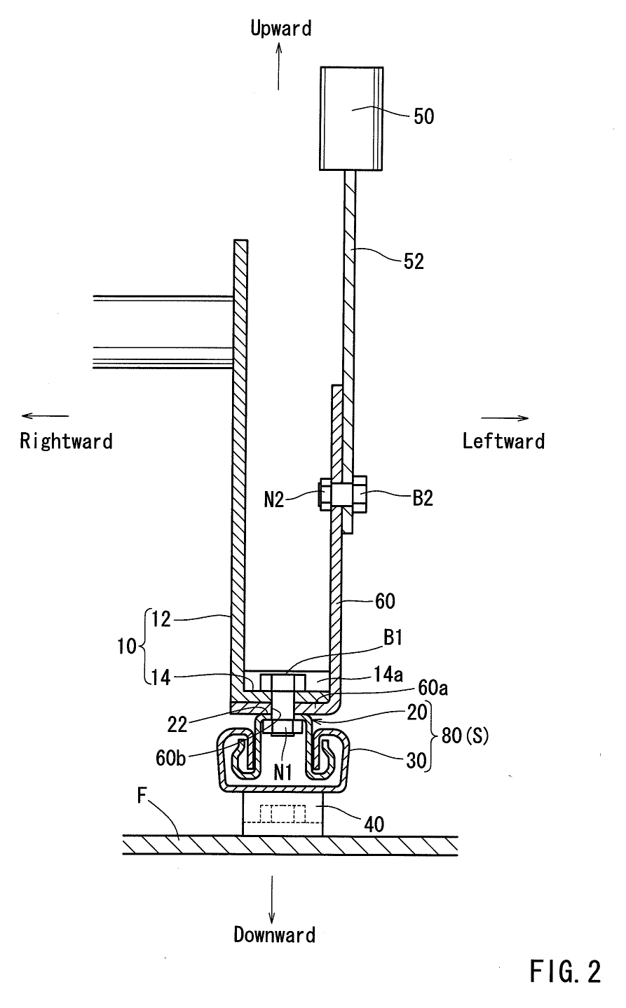

A detailed representative embodiment of the present invention will be described with reference FIGS. 1 and 2.

As shown in FIG. 1, a slidable vehicle seat (a driver seat) has a seat cushion frame 1, a seat back frame 2 that is rotatably connected to the seat cushion frame 1 via a reclining mechanism (not shown), and a slide mechanism S that is composed of a pair of slide rail assemblies 80. Naturally, the vehicle seat has a seat cushion pad, a seat cushion cover, a seat back pad and a seat back cover. However, the pads and the covers are omitted in the drawings for clarity.

The seat cushion frame 1 has a pair of (inner and outer/right and left) plate-shaped lower arms 10 (base frames). The lower arms 10 are positioned in parallel so as to be laterally spaced at a desired distance, and are integrally connected to each other via a pair of lateral frame elements 11. Each of the lower arms 10 has a vertical main arm portion 12 (a main wall portion) and a horizontal lower attachment portion 14 (a bottom wall portion). The lower attachment portion 14 may preferably be formed by bending a lower end portion of the main arm portion 12 at a right angle such that the lower arm 10 can have a substantially L-shape in cross section (FIG. 2). Further, the lower arm 10 may preferably be formed in one piece by press molding.

Each of the slide rail assemblies 80 of the slide mechanism S is constituted of a gutter-shaped lower rail 30 (a fixed member) and an upper rail 20 (a slide member). The lower rails 30 are disposed on a vehicle floor F. The lower rails 30 are positioned in parallel so as to be laterally spaced at a desired distance that is substantially equal to the distance between the lower arms 10. The lower rails 30 thus positioned are fixedly connected to the vehicle floor F via mounting blocks 40. Conversely, the upper rails 20 are respectively slidably coupled to the lower rails 21 so as to move back and forth therealong.

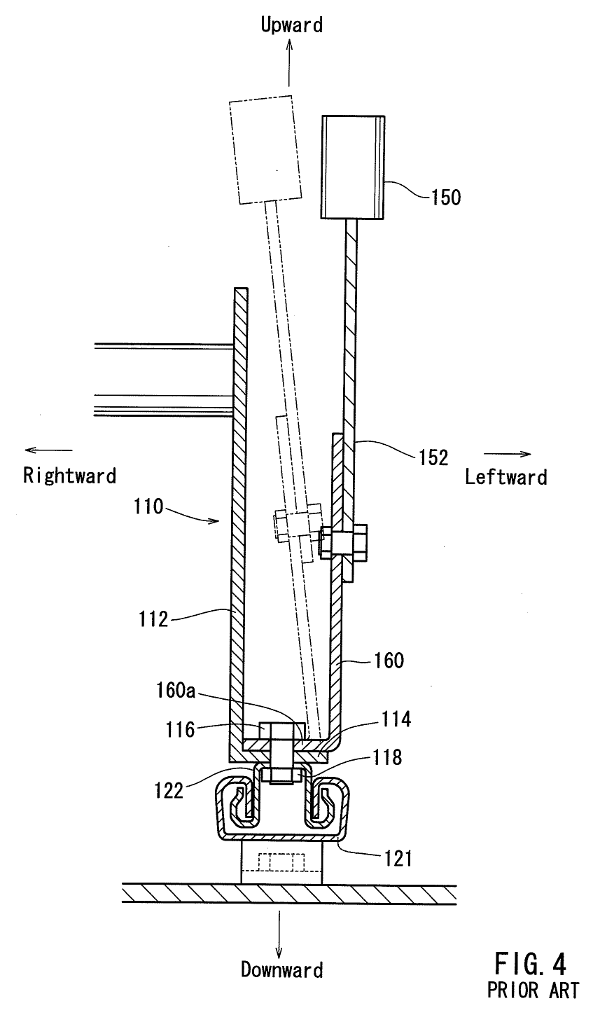

As shown in FIG. 1, the seat cushion frame 1 is disposed on the slide rail assemblies 80 (the slide mechanism S) such that the lower attachment portions 14 of the lower arms 10 are respectively seated on upper surfaces 22 of the upper rails 20. Each of the lower attachment portions 14 of the lower arms 10 is connected to the corresponding upper rail 20 via a plurality of pairs (two pairs in this embodiment) of bolts B1 and nuts N1 (FIG. 4). The two (front and rear) pairs of the bolts B1 and the nuts N1 will respectively be referred to as fasteners.

The vehicle seat further has a seatbelt buckle 50. As will be appreciated, the seatbelt buckle 50 may function to engage a tongue (not shown) that is attached to a seatbelt (not shown) in order to restrain a passenger or occupant (not shown) sitting on the vehicle seat. The seatbelt buckle 50 is attached to the seat cushion frame 1. In particular, a seatbelt anchor 52 is integrally connected to the seatbelt buckle 50. The seatbelt anchor 52 is connected to a seatbelt anchor bracket 60 via a bolt B2 and a nut N2 (FIG. 2). The seatbelt anchor bracket 60 has a lower bent portion 60a that is formed by bending a lower end portion thereof at a right angle such that the seatbelt anchor bracket 60 can have a substantially L-shape in cross section (FIG. 2). As best shown in FIG. 2, the lower bent portion 60a is disposed (interleaved) between the lower attachment portion 14 of the inner (left) lower arm 10 and the upper surface 22 of the upper rail 20 and is fastened therebetween via one (the rear pair) of the two pairs of the bolts B1 and the nuts N1. Further, a through hole 60b may preferably be formed in the lower bent portion 60a such that the bolt B1 can be inserted therethrough. Therefore, the seatbelt anchor bracket 60 is immovably fixedly connected to the inner lower arm 10 while the lower bent portion 60a is sandwiched between the lower attachment portion 14 of the inner lower arm 10 and the upper surface 22 of the upper rail 20. Thus, the seatbelt buckle 50 can be attached to the seat cushion frame 1 (the inner lower arm 10) via the seatbelt anchor bracket 60.

Further, as shown in FIG. 1, a (vertical) flanged portion 14a is formed in a rear end periphery of the lower attachment portion 14 of the inner lower arm 10. The flanged portion 14a may preferably be formed by upwardly bending the rear end periphery of the lower attachment portion 14 at a right angle.

According to the vehicle seat of the present embodiment, the seatbelt anchor bracket 60 can be fixedly connected to the inner lower arm 10 while the lower bent portion 60a is sandwiched between the lower attachment portion 14 of the inner lower arm 10 and the upper surface 22 of the upper rail 20. That is, the seatbelt anchor bracket 60 can be fixedly connected to the inner lower arm 10 while the lower bent portion 60a is pressed downwardly by the lower attachment portion 14 of the inner lower arm 10. Therefore, even if an excessively large force is applied to the seatbelt anchor bracket 60 via the seatbelt (e.g., when a vehicle collision happens), the seatbelt anchor bracket 60 can be effectively prevented from being deformed (extended) upwardly. As a result, restraint performance of the seatbelt can be effectively prevented from being reduced, so that the occupant sitting on the vehicle seat can be reliably restrained by the seatbelt.

In addition, because the lower attachment portion 14 of the inner lower arm 10 can have increased rigidity due to the flanged portion 14a formed therein, the lower attachment portion 14 can be highly strengthened or rigidified. Therefore, when the excessively large force is applied to the seatbelt anchor bracket 60, the lower bent portion 60a can be effectively pressed downwardly by the lower attachment portion 14, so that the seatbelt anchor bracket 60 can be reliably prevented from being deformed.

Various changes and modifications may be made to the present invention without departing from the scope of the invention. For example, in the embodiment, the driver seat is exemplified as the vehicle seat. However, the vehicle seat is not limited to the driver seat. That is, any seat (e.g., a passenger seat) other than the driver seat can be the vehicle seat.

What is claimed is:

1. A vehicle seat comprising:
a base frame;
a slide rail assembly having a slide member; and
a seatbelt anchor bracket,
wherein the base frame has a bottom wall portion that is connected to the slide member via a fastener, and wherein the seatbelt anchor bracket is fastened between the base frame bottom wall portion and the slide member via the fastener.

2. The vehicle seat as defined in claim 1, wherein a flanged portion is formed in a rear end periphery of the bottom wall portion.

3. The vehicle seat as defined in claim 1, wherein the fastener comprises a bolt and a nut, and wherein the bolt penetrates the seatbelt anchor bracket.

4. A vehicle seat in which a bottom wall portion of a lower arm is connected to an upper surface of an upper rail via front and rear bolts, comprising:
a seatbelt anchor bracket that is interleaved between the bottom wall portion of the lower arm and the upper surface of the upper rail,
wherein the rear bolt penetrates the seatbelt anchor bracket.

5. The vehicle seat as defined in claim 4, wherein a flanged portion is formed in a rear end periphery of the bottom wall portion.
